(19) United States
(12) Patent Application Publication
(10) Pub. No.: US 2019/0031571 A1
(43) Pub. Date: Jan. 31, 2019

(54) Brazeable Zirconia Ceramics, Methods Of Brazing Zirconia Ceramics, And Brazed Zirconia Ceramics

(71) Applicant: Morgan Advanced Ceramics, Inc., Hayward, CA (US)

(72) Inventor: Thomas Sandin, Redwood City, CA (US)

(21) Appl. No.: 16/071,672

(22) PCT Filed: Jan. 26, 2017
(86) PCT No.: PCT/EP2017/051692

§ 371 Date: Jul. 20, 2018

Related U.S. Application Data
(60) Provisional application No. 62/287,517, filed on Jan. 27, 2016.

(51) Int. Cl. C04B 37/02; C04B 37/00; B23K 1/00

(52) U.S. Cl. CPC C04B 37/023; C04B 37/003; B23K 1/00; C04B 2237/068; B23K 2103/52; C04B 2237/123; C04B 2237/408; C04B 2237/407; C04B 2237/55; C04B 2237/122

(57) ABSTRACT

A method of brazing a sintered zirconia ceramic body, comprises: providing a sintered zirconia ceramic body having a surface; chemically reducing the sintered zirconia ceramic body in whole or in part to form a reduced surface to the sintered zirconia ceramic body; applying a brazing material to at least part of the reduced surface to form an assembly comprising said brazing material and sintered zirconia ceramic body; heating said assembly to a temperature sufficient to at least partially melt the brazing material such that the brazing material wets the reduced surface; and cooling the assembly to solidify the brazing material.

This invention relates to brazeable zirconia ceramics, methods of brazing zirconia ceramics, and brazed zirconia ceramics.

### Zirconia Ceramics

By “zirconia ceramics” is meant ceramic materials comprising at least 5 wt % ZrO₂ and optionally at least 50 wt % ZrO₂, or at least 70 wt % ZrO₂, or at least 80 wt % ZrO₂, or at least 90 wt % ZrO₂.

Zirconia is an oxide (ZrO₂) that is used in ceramics but which, in its pure form, suffers from a tetragonal/monoclinic phase change that makes manufacture of sintered bodies of pure zirconia ceramics difficult. For this reason zirconia ceramics for use as sintered bodies generally comprise other components that lock the material wholly or partially into a high temperature cubic phase or stabilise the tetragonal phase. Typical components to achieve this effect include, for example, CaO, MgO and Y₂O₃. Zirconia ceramics may also contain other components (e.g. hafnia, HfO₂).

Typical zirconia containing ceramics include (among other types):
Precipitation hardened/transformation toughened ceramics such as partially stabilised zirconia (PSZ) which comprises tetragonal t-ZrO₂ particles and stabilised cubic c-ZrO₂ grains [e.g. yttria stabilized zirconia (Y-PSZ), magnesia stabilized zirconia (MSZ) and ceria stabilized zirconia (CSZ)].
Tetragonal zirconia polycrystal ceramics (TZP) which comprise fine grained tetragonal t-ZrO₂ particles (e.g Y-TZP).
Zirconia toughened ceramics (ZTC) which comprise tetragonal t-ZrO₂ particles or monoclinic m-ZrO₂ particles dispersed in another ceramic material (e.g. alumina [ZTA], mullite, or spinel).

It is known that reduction of zirconia results in a darkening of the ceramic from its normal white colour, and this has been attributed, at least in part, to the presence of zirconia sub oxides [ZrO₂₋ₓ] and (where yttria is present) yttria sub-oxides [Y₂O₃₋ₓ]. [“Origin of Darkening in 8 wt% Yttria-Zirconia Plasma-Sprayed Thermal Barrier Coatings”, Gabriel Maria Ingol, J. Am Ceram. Soc. 74(2), 381-86 (1991)]. Stronger coloration has been attributed to the presence of impurities such as iron [“Reply to “Comment on ‘Black Color in Partially Stabilized Zirconia’”], Javier Soria et al, J. Am Ceram. Soc. 74(7), 1747-48 (1991)]. Whatever the source, such darkening has been seen as a cosmetic disadvantage.

Darkening of a dense Y-TZP monolith and its fracture toughness has been reported in “Mechanical and Magnetic properties of Novel Yttria-Stabilized Tetragonal Zirconia/Ni Nanocomposite prepared by the Modified Internal Reduction Method”, Kondo et al, J. Am Ceram. Soc. 88(6), 1468-1473 (2005)]. No significant change in fracture toughness was shown following heat treating in a pure hydrogen atmosphere at 1300° C. for 2.5 hours.

### Brazing

Brazing and soldering are processes in which a molten filler metal (frequently referred to as a filler) is used to wet facing surfaces of a joint, and is then solidified on cooling to form a joint between the facing surfaces. Reaction or alloying at the junction between the brazing material and the articles to be joined may occur to a limited extent. Conventionally, brazing takes place above 450° C. and soldering at or below that temperature.

Brazing can also be used to provide a metallized surface to an article, or to provide electrically conductive pathways through articles.

According to “Principles of Brazing” by Jacobson and Humpston, (ASM International, ISBN 0-87170-812-4), brazing has been known since about 3200BCE for joining metals, and so for some materials it could be considered a mature technology. However the range of materials that can be successfully brazed has been extended over recent years as methods have been developed to deal with such widely different materials as ceramics, glasses and composite materials. For example “active brazes” incorporate in otherwise conventional brazing alloys a small amount of metals such as titanium, zirconium, hafnium, vanadium, niobium, tantalum, chromium, molybdenum, tungsten, or silicon, to improve wetting and spread on ceramic materials.

For brazing to occur, the brazing material normally has a liquidus temperature below the solidus temperature of the materials to be brazed, and the temperatures used for brazing must not detrimentally affect the materials to be joined.

A significant factor in assessing the quality of a brazed joint to ceramic is the shear strength at the joint. If the joint shears within the ceramic rather than in the braze, or at the braze-ceramic interface, then the braze does not represent a region of weakness.

### Brazing Zirconia Ceramics

When brazing zirconia ceramics, it is known to use active brazes, however such active brazes have some drawbacks:—
they tend to cause discoloration to the ceramic surrounding the braze, which is not only unsightly, it also makes it difficult to visually assess the presence of any surface contamination, or indeed the discoloration may be seen as a surface contamination;
the discoloration caused in brazing is hard to control, resulting in variability of appearance between brazed products—this variability in appearance casts doubt in the mind of users of the brazed products;
the active brazes work in part through reaction with the ceramic surface, which can sometimes cause problems in the strength of the braze if the reaction zone is too thick;
to produce a good bond, high levels of vacuum or a pure argon atmosphere is required.

Brazing zirconia ceramics, with a brazing alloy other than active brazes, does not work as the alloys do not wet to the zirconia ceramics.

### Scope of the Disclosure

The present disclosure provides improved zirconia materials providing improved brazing, and can avoid the use of active braze alloys.

The inventors have found that providing a reduced surface to sintered zirconia ceramic bodies assists wetting of the bodies to metals, such that optionally brazing materials other than active braze alloys may be used.

The inventors have further found that such sintered zirconia ceramic bodies having a reduced surface (in particular, although not exclusively, by the use of reduction in a hydrogen atmosphere at an elevated temperature) have improved shear strength over sintered zirconia ceramic bodies exposed to the same elevated temperature under vacuum.

The scope of the invention is as set out in the claims, and in any new and inventive features described herein with reference to the following non-limitative description.

### BACKGROUND

At this time metallizing does not exist to permit the brazing of yttria stabilised TZP (YTZP) so the only way to braze is to use active brazing (ABA Alloys) in a vacuum furnace.

As part of a study into the brazing of zirconia materials, the inventor observed that exposing Y-TZP to a temperature of 1550° C. in a hydrogen atmosphere resulted in a uniformly darkened material having a shear strength more than 50% higher than a sample of the same material exposed to the same temperature, for the same time, in vacuum.

In looking more closely, the inventor realised that the material exposed to the hydrogen atmosphere had a surface that was more easily wetted by brazing alloys, including brazing materials other than active brazing alloys.

While the particular Y-TZP used in the following examples is uniformly darkened, under other conditions, the zirconia ceramics may only exhibit darkening at the surface.

### EXAMPLES

### The Zirconia Ceramic

The following examples illustrate but do not limit the invention and each use an injection moulded and sintered dense (>90% dense) material made from yttria stabilised TZP (YTZP) [made from TZ-3YSE-E grade zirconia powder supplied by Tosoh Corporation which had an analysed composition in weight percent:—Y₂O₃ 5.23%, Al₂O₃ 0.252%, SiO₂ at most 0.002%, Fe₂O₃ at most 0.002%, Na₂O 0.007%, ignition loss of 0.45%, balance zirconia].

The material, prior to brazing, had been fired in dry hydrogen (dew point −60° C. or better) at 1500° C. for 30 min and then cooled in dry hydrogen to 150° C.

This heat treatment turned the YTZP dark (material changing from white to black). The YTZP did not become electrically conductive.

Heat treatment temperatures that may be used include (without limitation)>1350° C., >1400° C., >1500° C., >1550° C.

### Example 1

The inventors have brazed articles to titanium, using a 50 μm (2 thousandth of an inch) thick foil of Ticuni® active brazing alloy (15 Cu, 15 Ni, 70 Ti) placed between the YTZP and the titanium. Brazing took place at 980° C. in vacuum.

A good joint resulted that did not pull apart with significant force and that was hermetic.

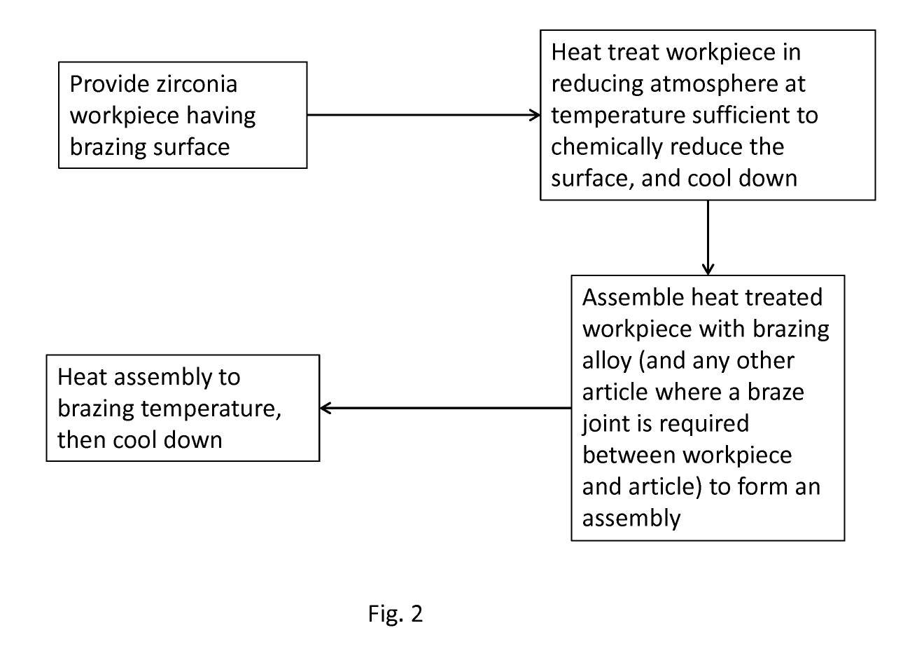

FIG. 2 shows an SEM micrograph of the braze, with the dense ceramic 1 joined to titanium 2 at joint 3

### Example 2

The heat treated YTZP of example 1 was brazed to titanium using a 50 μm (2 thousandth of an inch) thick pure gold foil as brazing material.

A good joint resulted that did not pull apart with significant force and that was hermetic.

### Example 3

The heat treated YTZP of example 1 was brazed to stainless steel using a 50 μm (2 thousandth of an inch) thick foil of copper-gold brazing alloy.

A good joint resulted showing good wetting of the YTZP.

### Example 4

The heat treated YTZP of example 1 was brazed to another piece of the heat treated YTZP of example 1 using a copper-silver alloy as brazing material.

A good joint resulted showing good wetting of the YTZP.

### Prospective Examples

Although exemplified with respect to TZP, improved wetting properties resulting from reduction of zirconia are predicted to apply to other zirconia containing ceramics such as PSZ and ZTC.

In light of the zirconia content, the improved strength is expected to apply at least to PSZ.

Optionally the zirconia ceramic may comprise other oxides that darken when exposed to reducing conditions (for example, and without limitation, one or more of: iron oxide, titanium oxide, cerium oxide, chromium oxide, nickel oxide, cobalt oxide) to enhance the uniformity and darkness of colour. Such elements need not be present in high quantities to provide such effect [e.g. <1%; <0.5%; <0.1%; <0.05%; <0.01%; or <0.005%] although if appropriate may be at higher levels.

### Typical Processing Steps

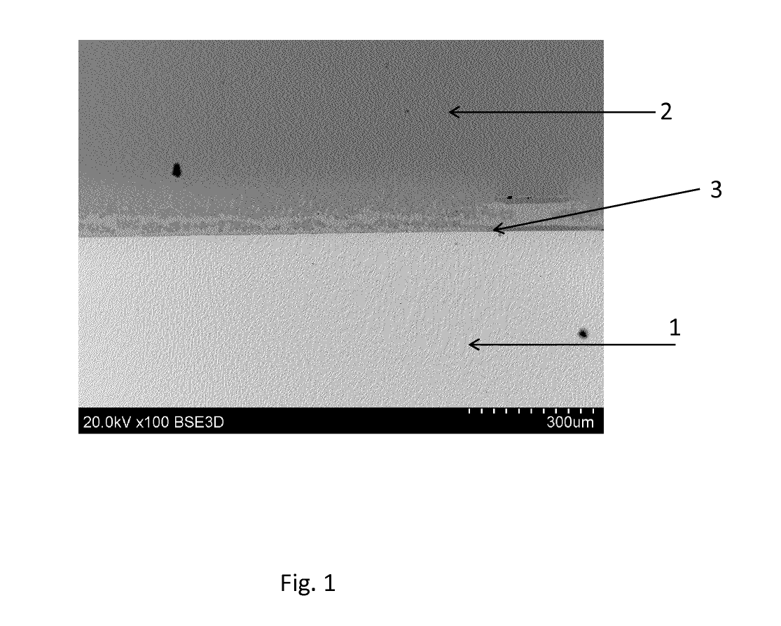

FIG. 1 shows typical processing steps in brazing according to the present invention.

### INDUSTRIAL APPLICABILITY

The invention is not limited to any particular brazing materials (other than that they are compatible both with the zirconia ceramic and any other article to which the ceramic is brazed), nor to any particular form of brazing material, and encompasses, for example, foils, pastes, powders, wires.

Brazed zirconia ceramics will have a variety of uses including (without limitation) in: medical implants, electrical feedthroughs, surgical equipment, analytical equipment, aerospace applications, oxygen sensors, fuel cell components.

The above description is illustrative only and the person skilled in the art will recognise that many variants may fall within the scope of the appended claims.

1. A method of brazing a sintered zirconia ceramic body, comprising:
providing a sintered zirconia ceramic body having a surface;
chemically reducing the sintered zirconia ceramic body in whole or in part to form a reduced surface to the sintered zirconia ceramic body;
applying a brazing material to at least part of the reduced surface to form an assembly comprising said brazing material and sintered zirconia ceramic body;
heating said assembly to a temperature sufficient to at least partially melt the brazing material such that the brazing material wets the reduced surface; and
cooling the assembly to solidify the brazing material.

2. A method of preparing a sintered zirconia ceramic body for brazing, comprising:
providing a sintered zirconia ceramic body having a surface comprising at least in part a region adapted to be brazed; and
chemically reducing the sintered zirconia ceramic body in whole or in part to form a reduced surface to the sintered zirconia ceramic body.

3. The method of claim 1, wherein chemically reducing the sintered zirconia ceramic body comprises exposing the sintered zirconia ceramic body to a reducing atmosphere.

4. The method of claim 3, wherein the reducing atmosphere comprises hydrogen.

5. The method of claim 1, wherein in which the sintered zirconia ceramic body comprises greater than 50 wt % zirconia.

6. The method of claim 5, wherein the sintered zirconia ceramic body is a tetragonal zirconia polycrystal ceramic.

7. A brazed article comprising a sintered zirconia ceramic body comprising a chemically reduced surface.
